(19) United States
(12) Patent Application Publication
(10) Pub. No.: US 2013/0343042 A1
(43) Pub. Date: Dec. 26, 2013

(54) RECHARGEABLE FLASHLIGHT

(71) Applicant: Gregory David Windom, Portland, OR (US)

(72) Inventor: Gregory David Windom, Portland, OR (US)

(73) Assignee: Coast Cutlery Company, Portland, OR (US)

(21) Appl. No.: 13/529,777

(22) Filed: Jun. 21, 2012

(51) Int. Cl. F21L 4/00; H01M 2/06; H01M 10/42; H01M 2/02

(52) U.S. Cl. 362/183; 429/178; 429/179; 429/164

(57) ABSTRACT

Embodiments are described which provide for a rechargeable battery pack for use in a flashlight. The rechargeable battery pack may include a rechargeable cell, one or more conductive contacts to provide power to a flashlight, and a charging port. The rechargeable battery pack may include these components as a self-contained unit inside a single casing. A flashlight may be configured to accept the rechargeable battery pack in a cavity of the flashlight as well as a non-rechargeable battery pack of a similar profile. Embodiments are also described which provide for a rechargeable pen light with conductive body portions, such that the pen light may be charged through insertion in a charging cover. Other embodiments may be described and claimed.

### TECHNICAL FIELD

Embodiments herein relate to the field of flashlights.

### BACKGROUND

Flashlights require stored energy to provide illumination. Oftentimes, flashlights will contain batteries or battery packs which have one or more powered cells to provide this energy. However, the use of disposable batteries is often considered wasteful and inconvenient.

Rechargeable batteries and battery packs are thus sometimes used in flashlights, but the use of rechargeable batteries may present its own problems. Often, the battery must be placed in a separate charging station to be recharged, requiring a user to carry and keep track of not only the flashlight and the battery, but also the charger.

### BRIEF DESCRIPTION OF THE DRAWINGS

Embodiments will be readily understood by the following detailed description in conjunction with the accompanying drawings and the appended claims. Embodiments are illustrated by way of example and not by way of limitation in the figures of the accompanying drawings.

FIGS. 1A-1C are various view of a rechargeable battery pack in accordance with various embodiments, including: (A) a bottom perspective view, (B) a side view, and (C) a top view;

FIG. 2 is a perspective view of the rear end of the rechargeable battery pack of FIG. 1;

FIGS. 3A and 3B are various perspective views of a rechargeable flashlight, in accordance with various embodiments;

FIG. 4 is an exploded view of the rechargeable battery pack of FIG. 1;

FIG. 5 is a front view of the rechargeable battery pack of FIG. 1;

FIG. 6 is a cross-section view of the of the rechargeable battery pack of FIG. 1;

FIG. 7 is an exploded view of a non-rechargeable battery pack in accordance with various embodiments;

FIG. 8 is a view of components of a rechargeable flashlight kit, in accordance with various embodiments;

FIG. 9 is perspective view of a rechargeable pen light kit with a rechargeable pen light and a charging cover, in accordance with various embodiments;

FIGS. 10A-10E are views of inner and outer components of a recharging stand for use with the rechargeable pen lights of FIG. 10, in accordance with various embodiments, including: (A) a first front view including inner components, (B) a first top view, (C) a second front view including inner components, (D) a second top view, and (E) a side view;

FIG. 11 is a fragmentary perspective view of inner components of another embodiment of a battery and charging system, showing only the front portion with the connectors disengaged;

FIG. 12 is a side elevation sectional view of the inner components of the embodiment of FIG. 11;

FIG. 13 is a perspective view of the inner components of the embodiment of FIG. 11 with the front end cover, the mini USB port and the rear printed circuit board disengaged; and

FIG. 14 is a perspective view of the embodiment of FIG. 11, fully assembled but with the charging plug disengaged

### DETAILED DESCRIPTION

In the following detailed description, reference is made to the accompanying drawings which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense, and the scope of embodiments is defined by the appended claims and their equivalents.

Various operations may be described as multiple discrete operations in turn, in a manner that may be helpful in understanding embodiments; however, the order of description should not be construed to imply that these operations are order dependent.

The description may use perspective-based descriptions such as up/down, back/front, and top/bottom. Such descriptions are merely used to facilitate the discussion and are not intended to restrict the application of disclosed embodiments.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

For the purposes of the description, a phrase in the form “A/B” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the terms “embodiment” or “embodiments,” which may each refer to one or more of the same or different embodiments. Furthermore, the terms “comprising,” “including,” “having,” and the like, as used with respect to embodiments, are synonymous, and are generally intended as “open” terms (e.g., the term “including” should be interpreted as “including but not limited to,” the term “having” should be interpreted as “having at least,” the term “includes” should be interpreted as “includes but is not limited to,” etc.).

With respect to the use of any plural and/or singular terms herein, those having skill in the art can translate from the plural to the singular and/or from the singular to the plural as is appropriate to the context and/or application. The various singular/plural permutations may be expressly set forth herein for sake of clarity.

Embodiments described herein provide a rechargeable battery pack, such as for use in a flashlight. The battery pack may include a rechargeable cell, such as a lithium ion rechargeable battery. The battery pack may also include a charging port, such as a mini- or micro-USB port, that is coupled to the rechargeable cell to facilitate charging of the rechargeable cell when a charging plug (e.g. a mini- or micro-USB cable) is plugged into the charging port. The battery pack may also contain one or more conductive contacts that are situated externally on the rechargeable battery pack to maintain contact with one or more contacts of a flashlight, thereby providing power to the flashlight. The battery pack may also include a casing that maintains the rechargeable cell, charting port, and conductive contacts as a self-contained unit. Thus, the rechargeable battery pack may provide a user with the ability to charge a removable battery for use in the flashlight without the use of external charging stations or devices.

Embodiments described herein also provide for a flashlight kit containing a rechargeable battery pack, such as described above, and a flashlight configured with a cavity to receive the rechargeable battery pack and conductive contacts to couple with the conductive contacts of the rechargeable battery pack to power the flashlight. The flashlight kit may also contain a non-rechargeable battery pack configured to hold one or more non-rechargeable cells and containing similar conductive contacts such that the non-rechargeable battery pack may also be placed in the cavity of the flashlight to power the flashlight.

Embodiments described herein are also directed to a rechargeable pen light. The rechargeable pen light may include one or more conductive portions on its body that may be contacted by a charging receptacle to charge a rechargeable cell within the pen light. The charging receptacle may be placed over the end of the pen light, such as over the end where the light assembly of the pen light is located. The charging receptacle may be a charging cover, such as on a flexible cable, or a charging stand, which may hold the pen light up during charging. The use of conductive portions of the body for charging allows the pen light to provide for recharging of the rechargeable cell without requiring that the rechargeable cell be removable. Additionally, the use of conductive portions of the body provides for a rechargeable pen light that does not require separate, specialized charging contacts for charging.

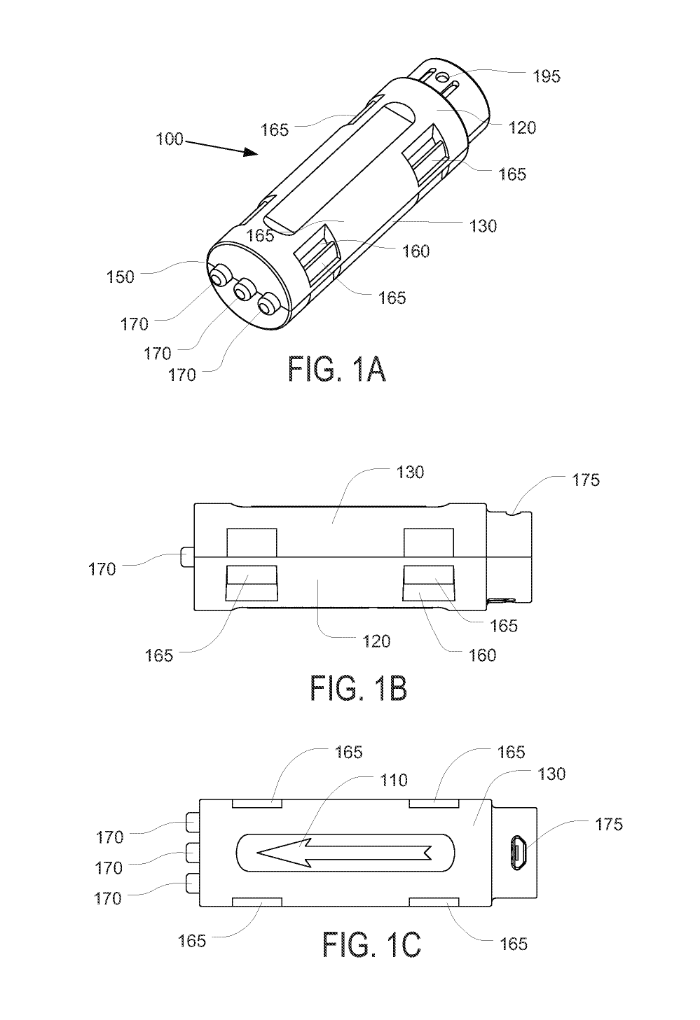

FIGS. 1A-1C show an example rechargeable battery pack 100. The rechargeable battery pack 100 may include a casing 150 to contain, or partially contain, various components of the rechargeable battery pack 100 as a self-contained unit. The casing 150 may include a top casing portion 130 and a bottom casing portion 120, which are shaped to meet along a longitudinal axis of the rechargeable battery pack 100. The top casing portion 130 may fasten to the bottom casing 120 to maintain a closed casing, such as through moveable resilient tabs 165 on the top casing portion, which may be inserted into slots 160 on the bottom casing portion, to fasten the two portions of the casing. In other embodiments, the top and bottom portions of the casing may be fastened using alternative methods and/or may meet at different regions of the rechargeable battery pack 100. The casing may also include a directional indicator 110, which may indicate to a user which direction to insert into a flashlight.

The rechargeable battery pack 100 may include one or more conductive power contacts 170, which may protrude, such as from cutouts in the casing 150. These conductive power contacts 170 may be coupled to an internal rechargeable cell, discussed herein, to facilitate conduction of power to a flashlight when the rechargeable battery pack is disposed such that the conductive power contacts 170 meet with conductive contacts of the flashlight. As illustrated, in some embodiments, the conductive power contacts 170 may be configured with some degree of radial symmetry (as may contacts in a flashlight using the rechargeable battery pack 100) such that a rotation of the rechargeable battery pack 100 in the flashlight does not disrupt a power circuit.

The rechargeable battery pack 100 may also include a charging port 175, which may be coupled to the rechargeable cell to provide power to the cell, such as from an external charging plug. The casing 150 may include a cutout to allow for access to the charging port 175. The rechargeable battery pack 100 may also include a charging indicator light 195, which may be coupled to one or more charging components to indicate when the rechargeable cell of the rechargeable battery pack 100 is being charged, as discussed herein. The charging indicator light 195 may be configured to illuminate with a first color during charge of the rechargeable cell and a different color when the rechargeable cell has been fully charged.

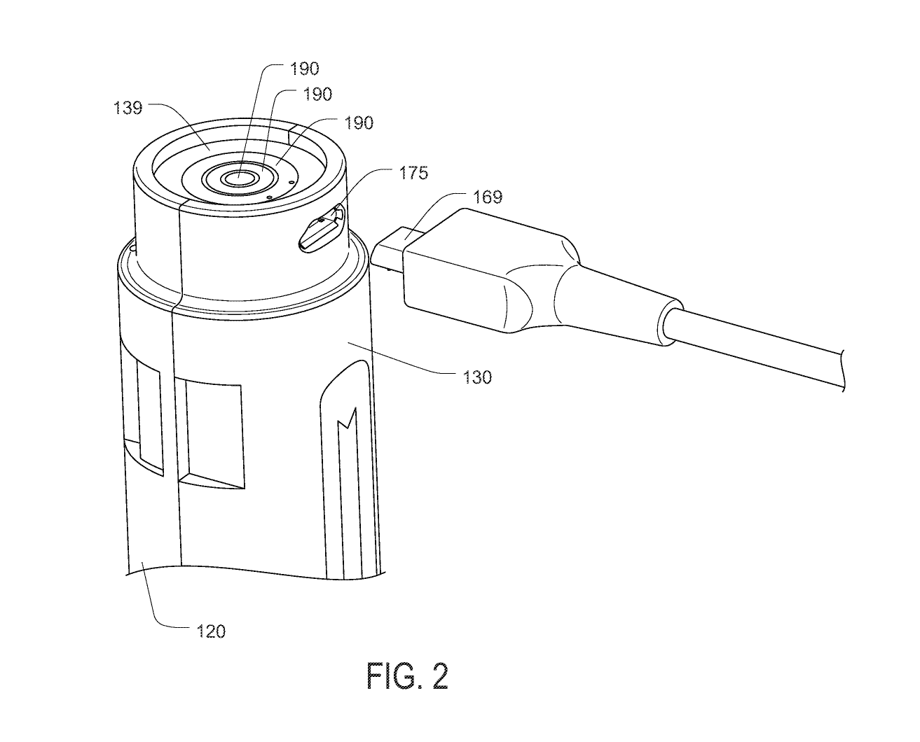

FIG. 2 illustrates an example rear end of the rechargeable battery pack 100. As illustrated, the rechargeable battery pack 100 may include a switch contact plate 139 that may include one or more conductive switch contacts 190. The conductive switch contacts may be configured to make contact with a switch for completing a circuit to power the flashlight when the rechargeable battery pack 100 is placed therein, as discussed below. As illustrated in FIG. 2, the charging port 175 may be connected to a charging plug 169, such as a mini-USB plug (as illustrated) or a micro-USB plug. In other embodiments, other combinations of charging port and charging plugs may be utilized.

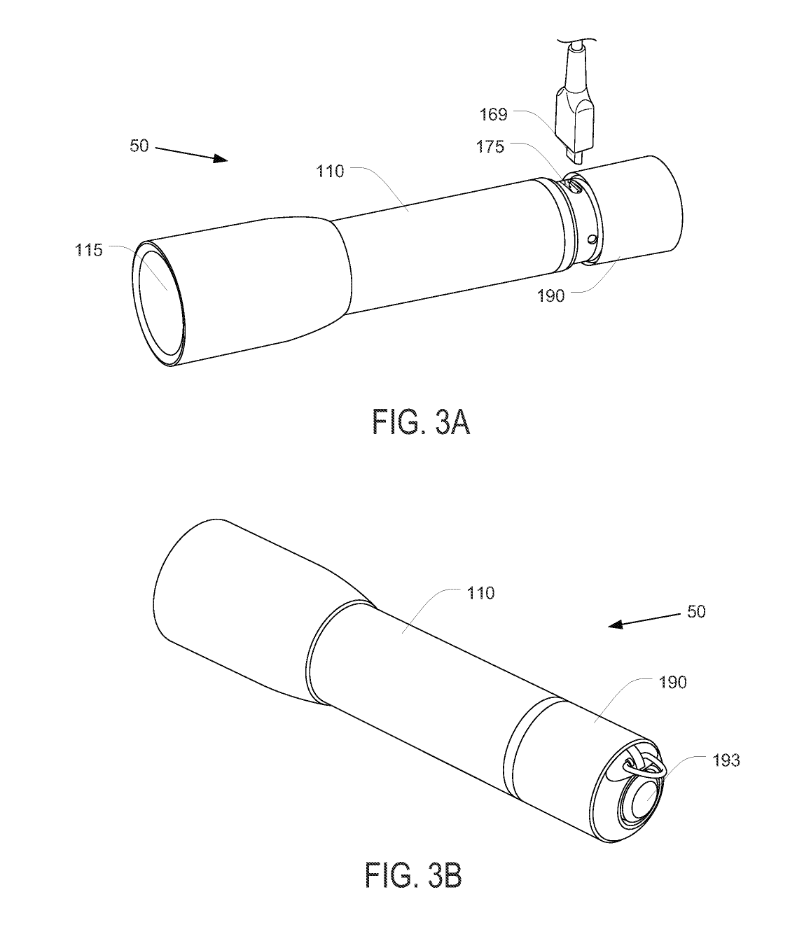

FIGS. 3A and 3B illustrate an example flashlight 50 configured to be powered by the rechargeable battery pack 100. The flashlight 50 may include a body 110 that includes a cavity to receive the rechargeable battery pack 100. The flashlight 50 may also include a light assembly 115 which may be powered by the rechargeable battery pack 100. The flashlight 50 may also include a cap 190. In some embodiments, the cap 190 may include a switch 193, which may control completion of a circuit with the rechargeable battery pack 100 to provide power to the light assembly 115. The cap may also be configured to be removed to provide access to the rechargeable battery pack 100 when the rechargeable battery pack 100 is disposed in the cavity of the flashlight 50. As the example in FIG. 3A illustrates, in some embodiments, the cavity of the flashlight 50 may be shorter than the length of the rechargeable battery pack 100 such that, when the cap 190 is removed, the charging port 175 may be accessed.

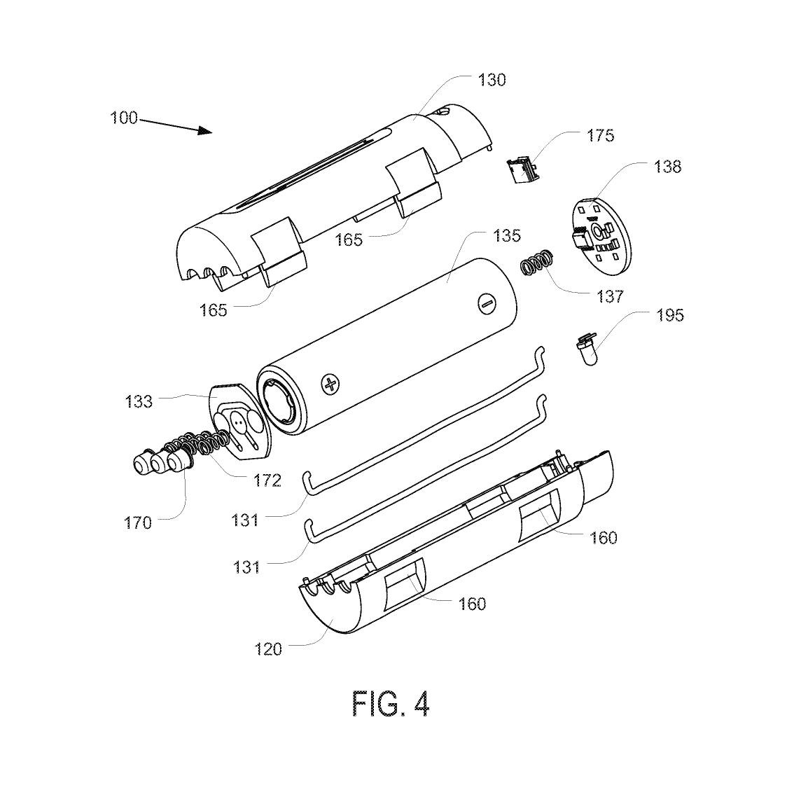

FIG. 4 illustrates an example exploded view of the rechargeable battery pack 100. The rechargeable battery pack 100 may include a rechargeable cell 135, such as a lithium-ion battery. In other embodiments, other rechargeable cells may be used. The rechargeable cell 135 may be coupled to a printed circuit board 133, which may be coupled to the conductive power contacts 170, such as through springs 172. Additionally, the rechargeable battery pack 100 may include a charging system 138, which may be coupled to the charging port 175 as well as the rechargeable cell 135 (such as through spring 137) to facilitate charging of the rechargeable cell 135 from the charging port 175. The charging system 138 may also be coupled to the printed circuit board 133 through one or more wires 131. In some embodiments, the charging system 138 may also include the switch contact plate 139 on an opposite side from where the charging system 138 makes couples to the rechargeable cell 135. In other embodiments, the charging system 138 and the switch contact plate 139 may include separate components.

In some embodiments, the charging system 138 may be configured to control aspects of charging of the rechargeable cell 135, such as rate of charge. For example, the charging system 138 may be configured to slow down, or stop, charging of the rechargeable cell 135 when the rechargeable cell is fully charged.

The charging system 138 may also be coupled to the charging indicator light 195. In various embodiments, as described above, the charging system may be configured to cause the light to be illuminated to display a charging status of the rechargeable battery pack 100. For example, the charging indicator light 195 may be configured to illuminate with a first color during charge of the rechargeable cell and a different color when the rechargeable cell has been fully charged.

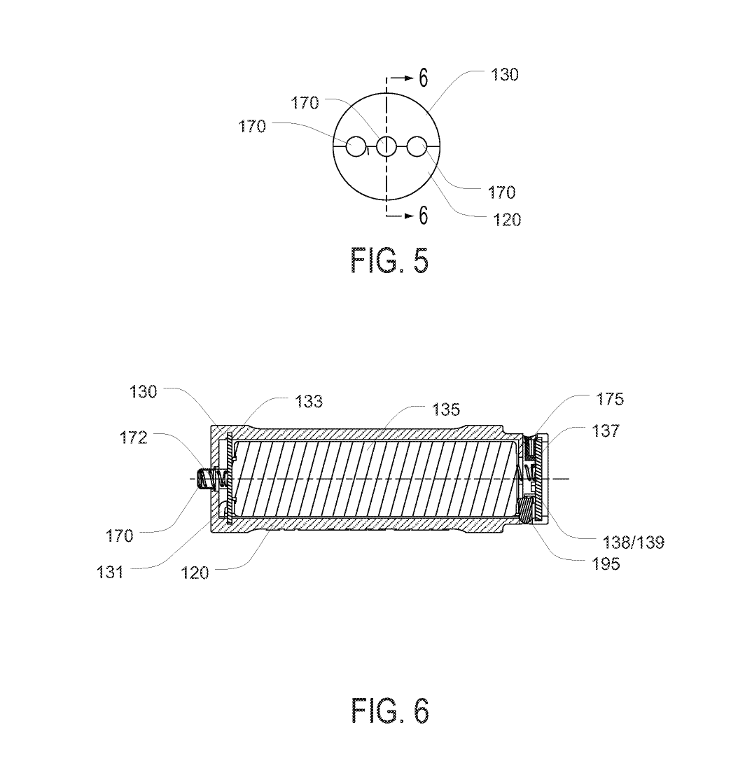

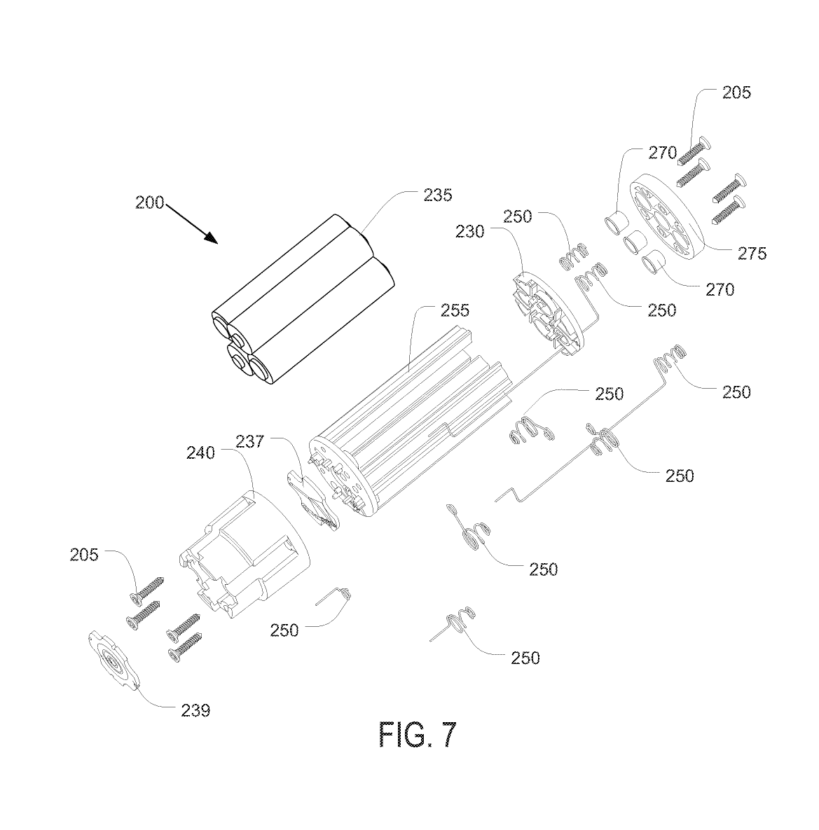

FIG. 5 shows a front end view of the rechargeable battery pack 100, showing the conductive power contacts 170 and the casing 150 (marked as casing portions 130 and 120). FIG. 6 illustrates a the rechargeable battery pack 100 as a cross-section of the front-end view of FIG. 5. As illustrated in FIG. 6, when the casing 150 is fastened around the various components shown at FIG. 4, the rechargeable cell 135 may be coupled to the contacts 170 at the front end of the rechargeable battery pack 100. Further, the charging system 138/switch contact plate 139 may be connected to the rechargeable cell 135 through the printed circuit board 133 and the wire 131, as well as spring 137, to complete a circuit for both charging and for providing power to the light assembly 115. In other embodiments, other conducting components may be used to complete the circuit.

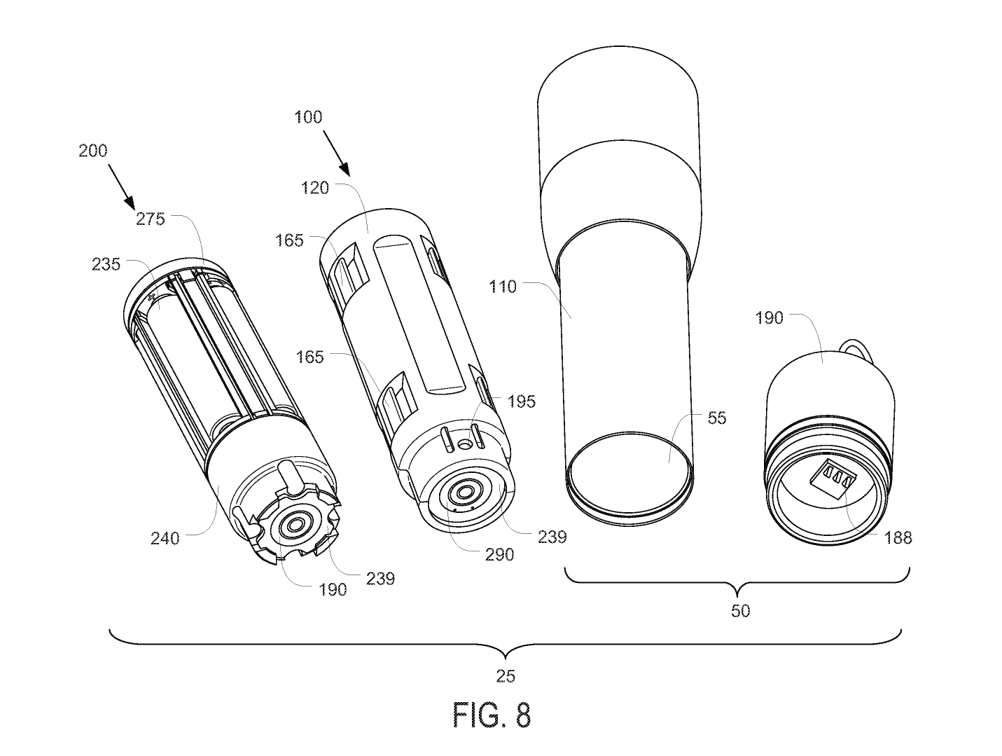

FIG. 7 illustrates an example non-rechargeable battery pack 200 for use with flashlight 50. As illustrated, the non-rechargeable battery pack 200 may include one or more non-rechargeable cells 235, such as AA or AAA batteries, or other types of batteries or power cells. These non-rechargeable cells may be held in a trestle 255, and held in place through one or more conductive springs 250. These conductive springs 250 may act as electrical leads to complete a power circuit with the flashlight 50. A short-circuit-proof circuit set 237 may also be coupled to the conductive springs 250 and the non-rechargeable cells to protect the circuit from forming a short circuit.

At the back end, the non-rechargeable battery pack 200 may include a switch contact plate 239. This switch contact plate 239 may have similar conductive switch contacts to the conductive switch contacts 190 of the switch conductive plate 139 of the rechargeable battery pack 100 to allow for use of the non-rechargeable battery pack 200 with the switch 193 of the cap 190 of the flashlight 50. At the front end, the non-rechargeable battery pack 200 may include one or more conductive power contacts 270, which may be coupled to the non-rechargeable cells through the one or more springs 250. The conductive springs may, in turn be held through plate 230, circuit cover 240, and contact cover 275, which may be assembled together and fastened, such as through screws 205.

In some embodiments, the assembly of the trestle 255, spring 250, plate 230, circuit cover 240, contact cover 275, switch contact plate 238, and conductive power contacts 270 may provide one or more cavities to securely insert the non-rechargeable cells 235 in a form factor that is similar to the rechargeable battery pack 100. Thus, the non-rechargeable battery pack 200 may be used to power flashlight 50 through disposal in the cavity of the flashlight 50 in a manner similar to the rechargeable battery pack 100. In some embodiments, the conductive power contacts 270 may also be configured with some degree of radial symmetry (as may contacts in flashlight 50 using the non-rechargeable battery pack 200) such that a rotation of the non-rechargeable battery pack 200 in the flashlight 50 does not disrupt a power circuit.

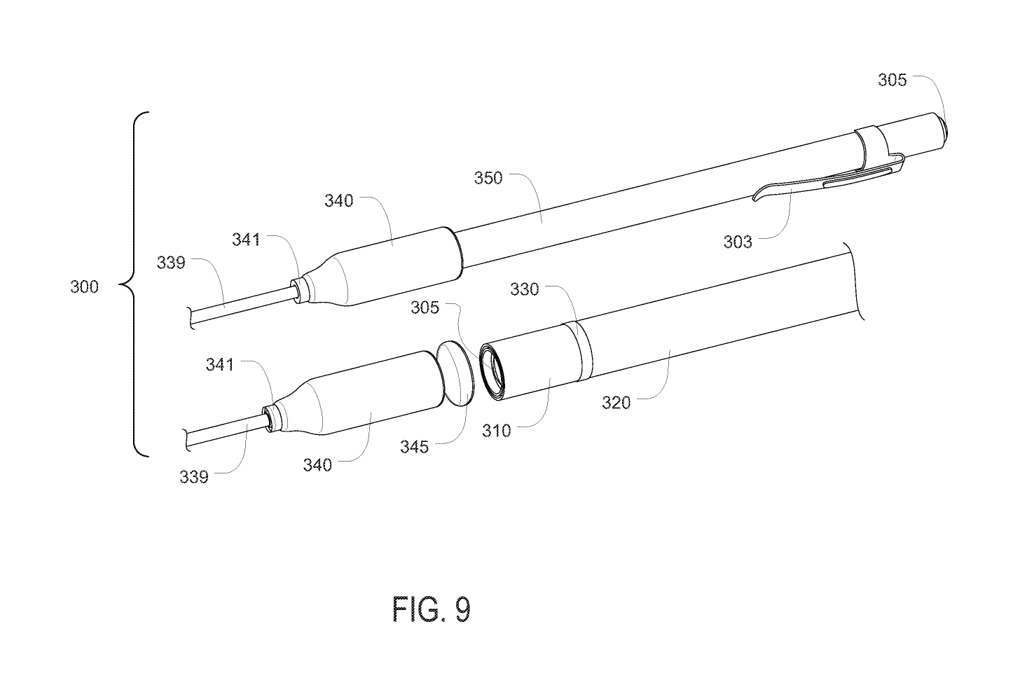

FIG. 8 illustrates an example flashlight kit 25. The flashlight kit may contain the flashlight 50 as well as the rechargeable battery pack 100. In some embodiments, the flashlight kit 25 may also include the non-rechargeable battery pack 200. FIG. 8 also illustrates the flashlight cavity 55, where the rechargeable battery pack 100 and/or the non-rechargeable battery pack 200 may be placed to power the flashlight 50, as well as cap switch contacts 138, which may couple with the switch conductive contacts 190 and 290 in order to complete a circuit for powering the flashlight 50 through the switch 193.

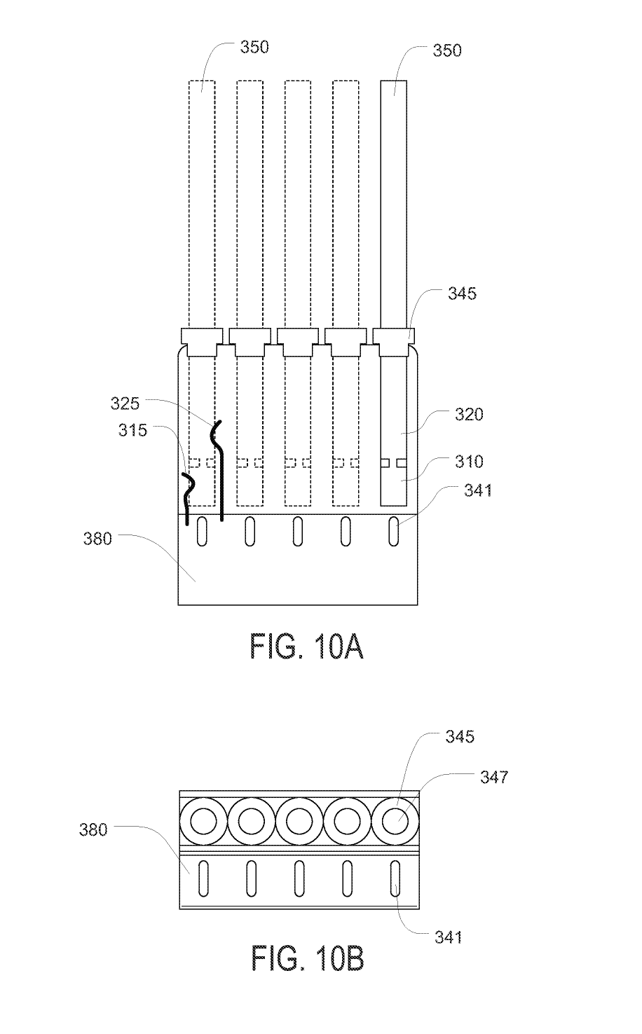

FIG. 9 illustrates two views of an example rechargeable pen light 350 as part of an example pen light kit 300. As illustrated, the rechargeable pen light may be substantially cylindrical in shape. Thus, in some embodiments, the rechargeable pen light may have a longitudinal axis and a circular cross section. Additionally, the rechargeable pen light may have a substantially constant diameter from one end to the other.

The rechargeable pen light 350 may be coupled with a charging receptacle 340. As in the illustrated example, the charging receptacle 340 may be a charging cover, which may be attached directly to a cable 339, from which power may be drawn. The charging cover may also include a charging indicator light 341, which may indicate a status of a charging process, as described above.

The charging receptacle 340 may contain one or more conductive contacts that may be configured to come into selective contact with portions of the rechargeable pen light 350. These contacts may be connected to one or more electrical leads in order to charge an internal rechargeable cell of the rechargeable pen light 350 (not shown). As illustrated, these portions may include conductive portions of the body of the rechargeable pen light 350, such as conductive portions 310 and 320. In some embodiments, a non-conductive portion of the body 330 may be disposed in between these two conductive portions. In some embodiments one or both of the conductive portions 310 and 320 may include an entire circumference of the rechargeable pen light. In these embodiments, the charging receptacle may be able to be placed on the rechargeable pen light 350 and rotated while still maintaining conductive contact with the conductive portions 310 and 320.

In some embodiments, one of the conductive portions may be disposed proximate to or at an end of the rechargeable pen light 350 to allow for easier access by the charging receptacle 340. Thus, in the example shown, the conductive portion 310 is located at the front end of the rechargeable pen light 350, adjacent to a light assembly 305. In other embodiments, one of the conductive portions may be located at the back end of the rechargeable pen light opposite from the light assembly 305. This may be undesirable in some embodiments, however, because the back end of the rechargeable pen light may be used for a switch, such as switch 305, or a clip, such as clip 303. In some embodiments, the rechargeable pen light may have a substantially constant diameter or a tapering diameter near the end used for charging in order to facilitate covering of the end by the charging receptacle.

In some embodiments, the rechargeable pen light may have a diameter that is smaller than the inner diameter of the charging receptacle. Thus, in some embodiments, the rechargeable pen light kit 100 may include a size-conversion seat 345 in the shape of a ring. The size-conversion seat 345 may include an inner diameter the size of the diameter of the rechargeable pen light 350, as well as an outer diameter the size of the inner diameter of the charging receptacle 340. In some embodiments, the size-conversion seat 345 may include a flare such that part of the size-conversion seat 345 is larger than the inner diameter of the charging receptacle 340. This configuration of the size-conversation seat 345 may provide a user to be able to insert the size-conversation seat 345 into the charging receptacle while still being able to easily remove the size-conversation seat 345 at a later time.

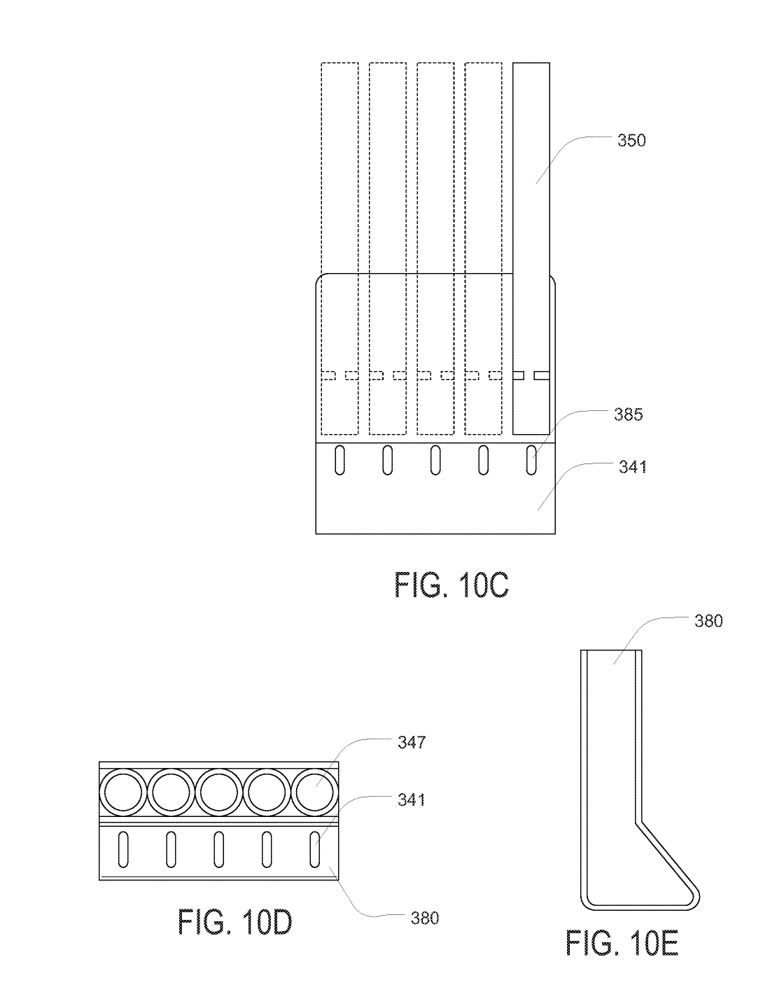

FIGS. 10A-E illustrates an example charging stand 380 serving as one implementation of the charging receptacle 340. The charging stand 380 may include one or more cavities 347 which may receive one or more of the rechargeable pen lights 350. In some embodiments, because the rechargeable pen light 350 may have a smaller diameter than the cavities 347, one or more size-conversion seats 345 may be included to be inserted into the cavities 347 to stabilize the rechargeable pen lights 350 during charging. As illustrated, FIGS. 10A and 10B illustrate charging with the use of the size-conversion seats 345, while FIGS. 10C-E illustrate charging without the size-conversion seats 345.

As illustrated in FIG. 10A, the charging stand 380 may include first and second conductive contacts 315 and 325. As mentioned above, these contacts may be connected to one or more electrical leads in order to charge the internal rechargeable cell of the rechargeable pen light 350. These conductive contacts may be sized so as to reach, respectively, the first conductive portion 310 and the second conductive portion 320. In some embodiments, the first and second conductive contacts 315 and 325 may include resilient metal and be deflected inward, so that they may dispose themselves against the body of the rechargeable pen light upon seating of the rechargeable pen light 350 in the cavity 347. The first and second conductive contacts 315 and 325 may additionally maintain contact with the first conductive portion 310 and the second conductive portion 320 during the time the rechargeable pen light 350 is seated in the cavity 347. During charging, one or more charging indicator lights 341 may illuminate to show a charging status, as discussed above.

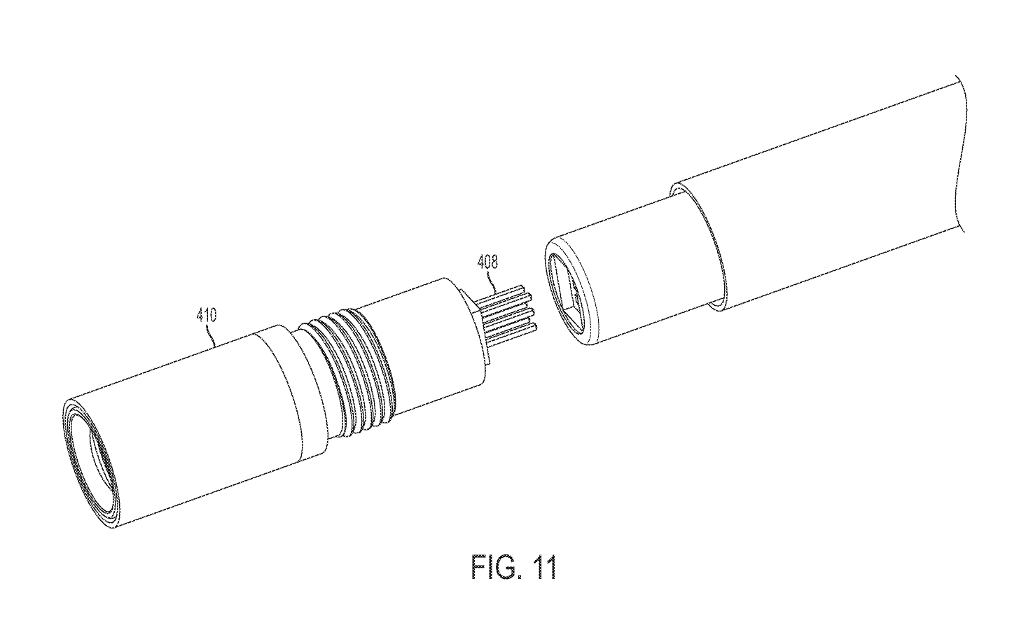

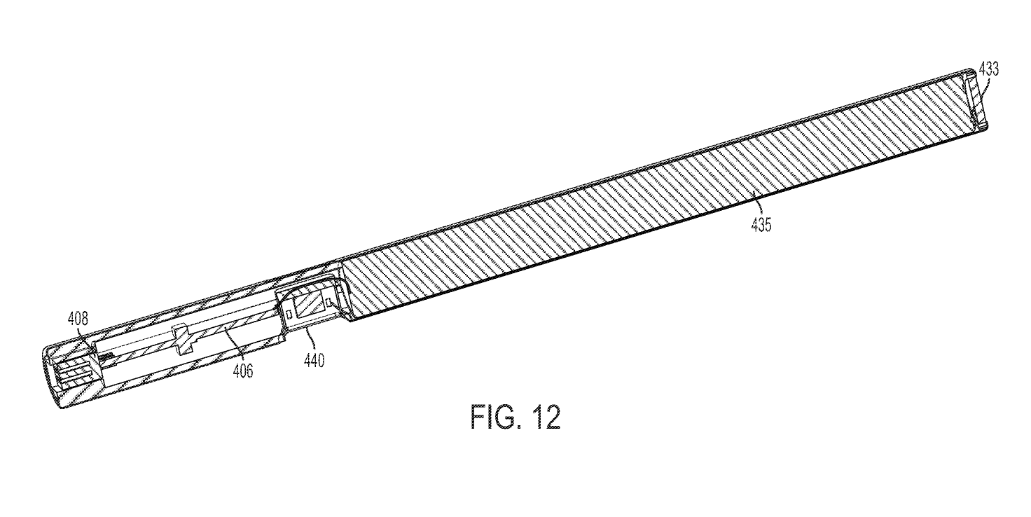

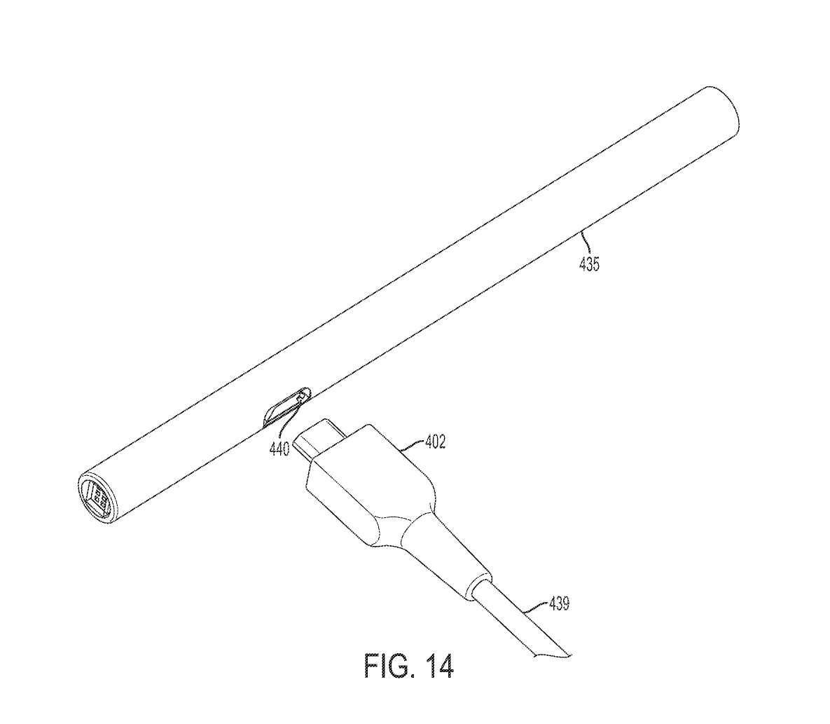

FIGS. 11-14 illustrate a battery and charging system that may be used with the rechargeable pen light 350 of FIG. 9. This battery and charging system may include a charging plug 402 (see FIG. 14) that may be coupled with a charging receptacle 440 having a charging cable 439 from which power may be drawn. The charging receptacle 440 may be in the form of a micro-USB port of conventional design, shown best in FIGS. 12 and 14.

The charging receptacle 440 may contain one or more conductive contacts that may be configured to come into selective contact with portions of the battery and charging system of FIGS. 11-14. These contacts may be connected to one or more electrical leads in order to charge an internal rechargeable cell 435. The rechargeable cell 435 may be in the form of one or more lithium ion batteries, although other rechargeable batteries may alternatively be used. The charging plug 402, charging receptacle 440 and charging cable 439 may thus be used to charge the rechargeable cell 435. As with earlier embodiments the charging system may be configured to control aspects of charging of the rechargeable cell 435, such as rate of charge. For example, the charging system may be configured to slow down, or stop, charging of the rechargeable cell 435 when the rechargeable cell is fully charged.

The battery and charging system may also be coupled to a charging indicator light (not shown) that causes the light to be illuminated to display a charging status of the rechargeable cell 435. For example, as with the prior embodiments a charging indicator light may be configured to illuminate with a first color during charge of the rechargeable cell and a different color when the rechargeable cell has been fully charged.

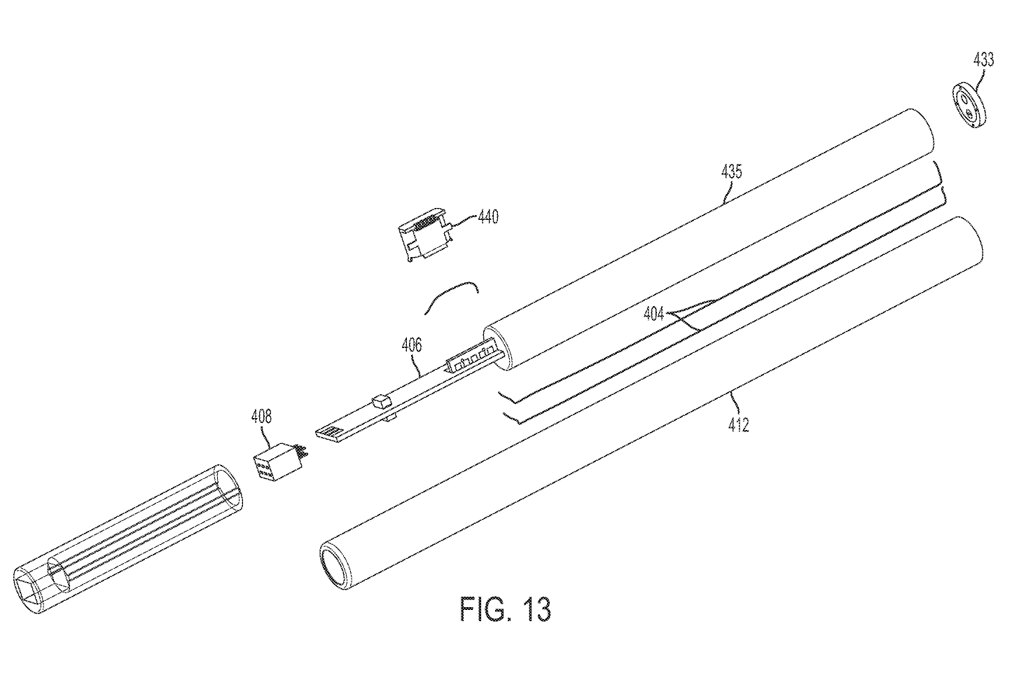

As shown best in FIGS. 12 and 13, the rechargeable cell 435 may be coupled at one end to a printed circuit board 433, which may be coupled to a switch (not shown). The charging receptacle 440 may be positioned at the opposite end of the rechargeable cell 435, as shown in FIG. 12, interconnected by wires 404. As noted earlier, the depicted embodiment includes a micro-USB port 440, that may include recharging and protective circuitry to control the recharging operation but protect the rechargeable cell from over-charging. As shown in FIG. 12, a second printed circuit board 406 is disposed forwardly of and is in electrical contact with the charging receptacle 440 and is in turn connected to a connector plug 408 that is designed to convey power from the rechargeable cell 435 to the front 410 of the battery and charging system that includes an LED. As shown in FIG. 13, a cylindrical wrapping 412 made of a nonconductive material such as PVC may be slid onto the battery and charging system, and a metallic cylinder may be slid over that to form the exterior of the pen light, such as pen light 350 depicted in FIG. 9.

Instead of having the micro-USB port 440, the battery and charging system of FIGS. 11-14 may be plugged to a charging system like that depicted in FIG. 9, showing the charging receptacle 340 fitting over the front 410 of the pen light. This variation has not been depicted in an additional view as it is deemed to be adequately described by combining the teachings of FIGS. 9 and 11-14.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope. Those with skill in the art will readily appreciate that embodiments may be implemented in a very wide variety of ways. This application is intended to cover any adaptations or variations of the embodiments discussed herein. Therefore, it is manifestly intended that embodiments be limited only by the claims and the equivalents thereof.

1. A rechargeable battery pack for a flashlight, comprising:
a rechargeable cell;
a charging port coupled to the rechargeable cell and configured to accept a charging plug to provide power to charge the rechargeable cell;
one or more first conductive contacts coupled to the rechargeable cell and arranged to couple with second conductive contacts of a flashlight; and
a casing disposed around the rechargeable cell, charging port, and one or more first conductive contacts to encase the rechargeable battery pack as a self-contained unit.

2. The rechargeable battery pack of claim 1, wherein the casing comprises:
a first cutout to allow for access by the charging plug to the charging port; and
one or more second cutouts to allow for access to the one or more first conductive contacts by the one or more second conductive contacts.

3. The rechargeable battery pack of claim 3, wherein:
the housing has a longitudinal axis and a substantially-circular cross section; and
the first cutout is disposed along the circumference of the substantially-circular cross section.

4. The rechargeable battery pack of claim 2, wherein:
the casing has a first end; and
the second cutouts are disposed on the first end of the housing.

5. The rechargeable battery pack of claim 1, further comprising a charging system configured to control conduction of power from the charging port to the rechargeable cell.

6. The rechargeable battery pack of claim 1, further comprising a charging indicator light.

7. The rechargeable battery pack of claim 1, wherein the casing comprises two casing portions configured to fasten together to encase the rechargeable cell, charging port, and one or more first conductive contacts.

8. The rechargeable battery pack of claim 1, wherein the charging port comprises a mini-USB port.

9. A flashlight kit, comprising:
a flashlight, comprising:
a light assembly;
a housing holding the light assembly and defining a cavity, the cavity configured to accept a battery pack, and the housing having one or more first contacts disposed to come into contact with the battery pack to provide power to the light assembly; and
a rechargeable battery pack comprising:
a rechargeable cell;
a charging port coupled to the rechargeable cell and configured to accept a charging plug to provide power to charge the rechargeable cell; and
one or more second contacts coupled to the rechargeable cell and disposed on the surface of the rechargeable battery pack to come into contact with the one or more first contacts when the rechargeable battery pack is placed in the cavity of the flashlight.

10. The flashlight kit of claim 9, further comprising a non-rechargeable battery pack comprising:
a trestle to hold one or more non-rechargeable cells; and
one or more conductive leads disposed in the housing to come in contact with the one or more non-rechargeable cells when the non-rechargeable cells are placed in the trestle;
one or more third contacts coupled to the one or more conductive leads and disposed on the surface of the non-rechargeable battery pack to come into contact with the one or more first contacts when the non-rechargeable battery pack is placed in the cavity of the flashlight.

11. The flashlight kit of claim 9, wherein the rechargeable battery pack further comprises a charging system configured to control conduction of power from the charging port to the rechargeable cell.

12. The flashlight kit of claim 9, wherein:
the cavity of the flashlight and the rechargeable battery pack have respective longitudinal axes and substantially-circular cross sections; and
when the rechargeable battery pack is placed in the cavity of the flashlight, the longitudinal axis of the rechargeable battery pack matches the longitudinal axis of the cavity of the flashlight.

13. The flashlight kit of claim 12, wherein the flashlight comprises a cap configured to couple with the housing to encase the battery pack.

14. The flashlight kit of claim 13, wherein the recharging battery pack has a length along the longitudinal axis greater than the length of the cavity of the flashlight when the cap is not coupled to the housing.

15. The flashlight kit of claim 14, wherein the charging port is disposed along the surface of the rechargeable battery pack such that the charging port remains accessible when the rechargeable battery back is placed in the cavity with the one or more first contacts are in contact with the one or more second contacts.

16. The flashlight kit of claim 15, wherein charging port is disposed along the longitudinal axis such that the charging plug may be accepted by the charging port in a direction of a diameter of the circular cross-section.

17. The flashlight kit of claim 12, wherein:
the rechargeable battery pack has a first end; and
the second contacts are disposed on the first end of the rechargeable battery pack.

18. The flashlight kit of claim 12, wherein the first contacts are disposed adjacent to the cavity and the second contacts are disposed on the surface of the rechargeable battery pack such that the first and second contacts are in contact with each other to provide power to the light assembly regardless of a rotation of the rechargeable battery pack along the longitudinal axis of the rechargeable battery pack.

19. A rechargeable flashlight, comprising:
a body having a first end, a second end, and a longitudinal axis;
a light assembly housed at the first end of the body;
a rechargeable cell coupled to the light assembly and housed in the body;
wherein:
the body has a first conductive portion and a second conductive portion located on the surface of the body and coupled to the rechargeable cell, the first conductive portion located proximate to either the first or second end of the body and the second conductive portion located between the first conductive portion and an end opposite to an end proximate to the first conductive region; and
when a charging receptacle is placed over the second end of the body, the charging receptacle having a cavity for receiving the second end of the body and first and second conductive contacts disposed within the cavity for providing charge to the rechargeable flashlight, the first conductive contact of the charging receptacle comes in contact with the first conductive portion and the second conductive contact of the charging receptacle comes in contact with second conductive portion to complete a circuit to charge the rechargeable cell.

20. The rechargeable flashlight of claim 19, wherein the first conductive portion is located at the first end of the body.

21. The rechargeable flashlight of claim 20, further comprising a switch at the second end of the body.

22. The rechargeable flashlight of claim 19, wherein the first and second conductive portions are separated on the surface of the body by a non-conductive region.

23. The rechargeable flashlight of claim 19, wherein the body has a circular cross-section and wherein one or both of the first conductive portion and the second conductive portion are disposed around respective first and second circumferences of the body.

24. The rechargeable flashlight of claim 22, wherein the body has a circular cross-section and wherein one or both of the first conductive portion and the second conductive portion are disposed entirely around respective first and second circumferences of the body.

25. The rechargeable flashlight of claim 22, wherein the first and second conductive portions are disposed such that, when the first and second contacts are in respective contact with the first and second conductive portions, the charging receptacle may be rotated around the longitudinal axis relative to the body without disrupting contact between the first and second contacts and the first and second conductive portions.

26. The rechargeable flashlight of claim 22, wherein the cross-section of the body is substantially constant along the longitudinal axis from the first end of the body to the second end of the body.

27. The rechargeable flashlight of claim 19, wherein the charging receptacle comprises a charging cover.

28. The rechargeable flashlight of claim 19, wherein the charging receptacle comprises a charging stand.

29. The rechargeable flashlight of claim 19, wherein the rechargeable flashlight comprises a pen light.

30. A rechargeable pen light kit comprising:
a rechargeable pen light, comprising:
a cylindrical body having a first end, a second end, a longitudinal axis;
a light assembly housed at the first end of the body;
a rechargeable cell coupled to the light assembly and housed in the body; and
a first conductive portion and a second conductive portion located on the surface of the body and coupled to the rechargeable cell, the first conductive portion located at the first of the body and the second conductive portion located between the first conductive portion and the second end of the body; and
a charging receptacle having a cavity for receiving the second end of the body and first and second conductive contacts disposed within the cavity for providing charge to the rechargeable pen light such that, when the rechargeable pen light is placed in the cavity of the charging receptacle, the first conductive contact of the charging receptacle comes in contact with the first conductive portion and the second conductive contact of the charging receptacle comes in contact with second conductive portion to complete a circuit to charge the rechargeable cell.

31. The rechargeable pen light kit of claim 29, wherein:
the rechargeable pen light has a circular cross section with a diameter; and
the cavity of the charging receptacle has a circular cross section with a diameter.

32. The rechargeable pen light kit of claim 30, wherein:
the diameter of the circular cross section of the cavity of the charging receptacle is larger than the diameter of the circular cross section of the rechargeable pen light; and
the rechargeable pen light kit further comprises a ring-shaped size-conversion seat with an inner diameter substantially similar to the diameter of the circular cross section of the rechargeable pen light, and an outer diameter at least as large as the circular cross section of the charging receptacle.

33. The rechargeable pen light kit of claim 29, wherein the charging receptacle is a stand.

34. The rechargeable pen light kit of claim 32, wherein the stand maintains the cavity in a vertical position such that the second end of the rechargeable pen light may be placed in the cavity from above.

35. The rechargeable pen light kit of claim 32, wherein the stand contains two or more cavities, each configured to accept and charge the rechargeable pen light.

36. The rechargeable pen light kit of claim 29, wherein the charging receptacle comprises an indicator light configured to illuminate when the charging receptacle is providing power to the rechargeable pen light.

37. The rechargeable pen light kit of claim 29, wherein the indicator light is configured to illuminate with a first color when the rechargeable pen light is being charged, and to illuminate with a second color when the rechargeable pen light is charged.
